(19) United States
(12) Patent Application Publication
(10) Pub. No.: US 2021/0171826 A1
(43) Pub. Date: Jun. 10, 2021

(54) CONVERTING INVERT EMULSIONS TO EMULSIONS USING POLYVALENT SALTS OF POLYMERIC WEAK ACIDS

(71) Applicant: ARC PRODUCTS, INC., Dallas, TX (US)

(72) Inventors: Caroline VITEAUX, Dallas, TX (US); Mark ALEXANDER, Dallas, TX (US); Michael HEATH, Dallas, TX (US)

(73) Assignee: ARC PRODUCTS, INC., Dallas, TX (US)

(21) Appl. No.: 17/268,630

(22) PCT Filed: Aug. 16, 2019
(86) PCT No.: PCT/US19/46766

§ 371 Date: Feb. 16, 2021

Related U.S. Application Data
(60) Provisional application No. 62/720,294, filed on Aug. 21, 2018.

(51) Int. Cl. C09K 8/88; C09K 8/82; C09K 8/035; C09K 8/40; E21B 43/00

(52) U.S. Cl. CPC C09K 8/885; C09K 8/82; C09K 2208/26; C09K 8/40; E21B 43/00; C09K 8/035

(57) ABSTRACT

An additive comprising: a polymeric weak acid, wherein the polymeric weak acid is in a free acid form or in a monovalent, divalent, or trivalent salt form of the polymeric weak acid, and wherein the additive converts an invert emulsion having an external phase comprising a hydrocarbon liquid to an emulsion having an external phase comprising water. The additive can be added to the invert emulsion in a dry form or included in a base fluid. The invert emulsion can include polyvalent cations. The base fluid can also include a second additive comprising polyvalent cations.

### TECHNICAL FIELD

Often there is a need to convert or flip an invert emulsion into an emulsion. An additive can be added to an invert emulsion to convert the external phase from a hydrocarbon liquid into an aqueous-based liquid.

### DETAILED DESCRIPTION

There are a variety of industries that encounter or use invert emulsions. It is often desirable to convert these invert emulsions into emulsions. One, non-limiting example of an industry that uses invert emulsions that need to be converted is the oil and gas industry.

As used herein, a “fluid” is a substance having a continuous phase that tends to flow and to conform to the outline of its container when the substance is tested at a temperature of 71° F. (22° C.) and a pressure of 1 atmosphere (atm) (0.1 megapascals (MPa). Because of the nature and distribution of their natural hydrocarbon components, some reservoir “fluids” require temperatures higher than 71° F. to flow and to conform to the outlines of their containers. In such cases, testing and field treatments are often done at those higher temperatures. A fluid can be a liquid or gas.

A homogenous fluid has only one phase, whereas a heterogeneous fluid has more than one distinct phase. A colloid is an example of a heterogeneous fluid. A colloid can be: a slurry, which includes an external liquid phase and undissolved solid particles as the internal phase; an emulsion, which includes an external liquid phase and at least one internal phase of immiscible liquid droplets; a foam, which includes an external liquid phase and a gas as the internal phase; or a mist, which includes an external gas phase and liquid droplets as the internal phase. As used herein, the term “emulsion” means a colloid in which an aqueous liquid is the continuous (or external) phase and a hydrocarbon liquid is the dispersed (or internal) phase. As used herein, the term “invert emulsion” means a colloid in which a hydrocarbon liquid is the external phase. Of course, there can be more than one internal phase of the emulsion or invert emulsion, but only one external phase. For example, there can be an external phase which is adjacent to a first internal phase, and the first internal phase can be adjacent to a second internal phase. Any of the phases of an emulsion or invert emulsion can contain dissolved materials and/or undissolved solids. In some cases, heterogeneous reservoir fluids can be complex combinations of the above that may change with changes in variables such as temperature, pressure, and shear.

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

A well can include, without limitation, an oil, gas, or water production well, or an injection well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore. As used herein, “into a subterranean formation” means and includes into any portion of a subterranean formation including, into a well, wellbore, or the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During wellbore operations, it is common to introduce a treatment fluid into the well. Examples of common treatment fluids include, but are not limited to, drilling fluids, spacer fluids, completion fluids, and work-over fluids. As used herein, a “treatment fluid” is a fluid designed and prepared to resolve a specific condition of a well or subterranean formation, such as for stimulation, isolation, gravel packing, or control of gas or water coning. The term “treatment fluid” refers to the specific composition of the fluid as it is being introduced into a well. The word “treatment” in the term “treatment fluid” does not necessarily imply any particular action by the fluid.

The treatment fluids generally contain a base fluid and one or more additives. As used herein, the term “base fluid” means the liquid that is in the greatest concentration and is the solvent of a solution or the continuous phase of a heterogeneous fluid. An example of a treatment fluid that is an invert emulsion is an oil-based drilling mud.

After a wellbore is formed using the drilling mud, the annulus can be cemented. However, for the cement to bond and set effectively, it is traditionally necessary to remove the residual drilling mud. A spacer fluid is typically introduced into the wellbore after the drilling mud and before the introduction of the cement. The spacer fluid functions to displace the drilling mud and provide a water wet surface for the cement. However, if the external phase of the invert emulsion drilling mud can be converted to an emulsion that contains an aqueous-based external phase, then any residual drilling mud remaining in the annulus would not prevent the cement from bonding and setting. Consequently, the need to introduce a spacer fluid would be eliminated. Thus, there is a need to convert the external phase of an invert emulsion to an aqueous-based external phase emulsion.

Despite current chemical knowledge, it has unexpectedly been discovered that a polymeric additive can be introduced into an invert emulsion whereby the additive converts the hydrocarbon liquid external phase of the invert emulsion into the internal phase of an aqueous-based external phase emulsion or dispersion. One of the advantages to the new polymeric additive is improved phase conversion of invert emulsions into aqueous-based external phase emulsions or dispersions. Another advantage of the new polymeric additive is that it can function in either a neat form or in conjunction with well-known surfactant additives for cleaning, dispersing, water-wetting, invert emulsion-breaking, and inhibition or prevention of invert emulsion formation that causes improved overall performance of a base fluid.

According to certain embodiments, a fluid comprises: a base fluid; and an additive, wherein the additive comprises a weak acid polymer, wherein the weak acid polymer chemically reacts with polyvalent cations to form a weak acid polyvalent cation salt via neutralization or ion exchange, and wherein the additive converts an invert emulsion having an external phase comprising a hydrocarbon liquid to an emulsion having an external phase comprising water.

According to certain other embodiments, a fluid comprises: a base fluid; and an additive, wherein the additive comprises a divalent or trivalent salt of a weak acid polymer, and wherein the additive converts an invert emulsion having an external phase comprising a hydrocarbon liquid into an emulsion having an external phase comprising water.

According to certain other embodiments, an additive comprises: a polymeric weak acid, wherein the polymeric weak acid is in a free acid form or in a monovalent, divalent, or trivalent salt form of the polymeric weak acid, and wherein the additive converts an invert emulsion having an external phase comprising a hydrocarbon liquid to an emulsion having an external phase comprising water.

It is to be understood that the discussion of preferred embodiments regarding the treatment fluid or any ingredient in the treatment fluid, is intended to apply to all of the composition and method embodiments. Any reference to the unit “gallons” means U.S. gallons.

The fluid can include a base fluid and the additive. The base fluid can include an aqueous liquid. The base fluid can be a solution or a colloid. The aqueous liquid can be selected from the group consisting of freshwater, saltwater, sea water, brackish water, and combinations thereof. The base fluid can include dissolved substances or undissolved substances.

The base fluid can also include a hydrocarbon liquid. Preferably, the hydrocarbon liquid is selected from the group consisting of: a fractional distillate of crude oil; a fatty derivative of an acid, an ester, an ether, an alcohol, an amine, an amide, or an imide; a saturated hydrocarbon; an unsaturated hydrocarbon; a branched hydrocarbon; a cyclic hydrocarbon; and any combination thereof. Crude oil can be separated into fractional distillates based on the boiling point of the fractions in the crude oil. An example of a suitable fractional distillate of crude oil is diesel oil. The saturated hydrocarbon can be an alkane or paraffin. Preferably, the saturated hydrocarbon is a paraffin. The paraffin can be an isoalkane (isoparaffin), a linear alkane (paraffin), or a cyclic alkane (cycloparaffin). Examples of suitable paraffins include, but are not limited to: BIO-BASE 360® (an isoalkane and n-alkane); BIO-BASE 300™ (a linear alkane); BIO-BASE 560® (a blend containing greater than 90% linear alkanes); and ESCAID 110™ (a mineral oil blend of mainly alkanes and cyclic alkanes). The BIO-BASE liquids are available from Shrieve Chemical Products, Inc. in The Woodlands, Tex. The ESCAID liquid is available from ExxonMobil in Houston, Tex. The unsaturated hydrocarbon can be an alkene, alkyne, or aromatic. Preferably, the unsaturated hydrocarbon is an alkene. The alkene can be an isoalkene, linear alkene, or cyclic alkene. The linear alkene can be a linear alpha olefin or an internal olefin. An example of a linear alpha olefin is NOVATEC™, available from M-I SWACO in Houston, Tex. Examples of internal olefins include, ENCORE® drilling fluid and ACCOLADE® drilling fluid, marketed by Halliburton Energy Services, Inc.

The fluid can be a variety of different types of fluids and be used in a variety of different types of industries and operations. According to certain embodiments, the fluid is used in an oil and gas operation. Non-limiting examples of oil and gas operations in which the fluid can be used include: preparing newly-drilled oil and gas well and equipment surfaces for successfully-bonded cement introduced subsequent to drilling with oil-based muds; discouraging or preventing invert emulsion formation while pumping oil and water mixtures through subterranean pores; dehydrating produced crude oil, as well as heating and mechanical techniques to “drop-out” enough of its internal salt water phase to render the crude oil dry enough for transportation, storage, and refining; and treating, cleaning, and/or separating components of “heavy” oil and “slop oil.” According to certain embodiments, the fluid is a spacer fluid that can be introduced into a wellbore after a drilling mud and before a cement composition.

The fluid includes the additive. The additive can include a water-soluble polymer. The additive can also be soluble in a hydrocarbon liquid. A polymer is a large molecule composed of repeating units, typically connected by covalent chemical bonds. A polymer is formed or synthesized from monomers. During the formation of the polymer, some chemical groups can be lost from each monomer. The piece of the monomer that is incorporated into the polymer is known as the repeating unit or monomer residue. The backbone of the polymer is the continuous link between the monomer residues. The polymer can also contain functional groups connected to the backbone at various locations along the backbone. Polymer nomenclature is generally based upon the type of monomer residues comprising the polymer. A polymer formed from one type of monomer residue is called a homopolymer. A copolymer is formed from two or more different types of monomer residues. The number of repeating units of a polymer is referred to as the degree of polymerization and defines the chain length of the polymer. The number of repeating units of a polymer can range from approximately 4 to greater than 10,000. In a copolymer, the repeating units from each of the monomer residues can be arranged in various manners along the polymer chain. For example, the repeating units can be random, alternating, periodic, or block. The conditions of the polymerization reaction can be adjusted to help control the average number of repeating units (the average chain length) of the polymer.

A polymer has an average molecular weight, which is directly related to the average chain length of the polymer. The average molecular weight of a polymer has an impact on some of the physical characteristics of a polymer, for example, its solubility and its dispersibility. For a copolymer, each of the monomers will be repeated a certain number of times (number of repeating units). The average molecular weight (M_{w}) for a copolymer can be expressed as follows:

M_{w}=ΣwₓMₓ

where wₓ, is the weight fraction of molecules whose weight is Mₓ.

In a copolymer, the repeating units from each of the monomer residues can be arranged in various manners along the polymer chain. For example, the repeating units can be random, alternating, periodic, or block. As used herein, a “polymer” can include a cross-linked polymer. As used herein, a “cross link” or “cross linking” is a connection between two or more polymer molecules. A cross-link between two or more polymer molecules can be formed by a direct interaction between the polymer molecules, or conventionally, by using a cross-linking agent that reacts with the polymer molecules to link the polymer molecules.

The polymer can be a homopolymer or a copolymer. The polymer can have a molecular weight and/or salt form selected such that the polymer is soluble in the base fluid. According to certain embodiments, the polymer has a molecular weight in the range of about 200 to about 500,000. The polymer can also have a molecular weight in the range of about 1,000 to about 100,000.

The polymer is a polymeric weak acid. The polymeric weak acid can be any of several polymeric weak acids that chemically react with polyvalent cations to form a weak acid salt. The polymeric weak acid can be, for example, selected from the group consisting of polycarboxylates, polyacrylates, polymaleates, polymethacrylates, polyfumarates, or polyitaconates. Examples of suitable homopolymer weak acids include, but are not limited to, polyacrylic acid, polymethacrylic acid, polyitaconic acid, polyfumaric acid, or polymaleic acid. The polymer can also be a copolymer that further includes other monomer residues, such as, but not excluding other monomer residues, 2-acrylamido-2-methylpropane sulfonic acid (AMPS).

The polymeric weak acid can chemically react with polyvalent cations to form a weak acid salt. Without being limited by theory, it is believed that the formation of a polymeric weak acid in a polyvalent cation salt form converts the external phase of an invert emulsion from a hydrocarbon liquid into an emulsion having an aqueous-based external phase.

According to a first embodiment, the polymeric weak acid is in a monovalent salt form. The monovalent salt form can be, by way of one example, a sodium or potassium salt form. According to a second embodiment, the polymeric weak acid is in a free acid form. According to these embodiments, the free acid form or monovalent cation salt form, can chemically react in-situ with available polyvalent cations to form a polyvalent cation salt of the polymeric weak acid.

According to the free acid form and monovalent cation salt form embodiments, the fluid can further include a second additive in the case where polyvalent cations are not available in-situ. The second additive can be any additive that has polyvalent cations (i.e., at least a divalent cation and not a monovalent cation) available to chemically react with one or more functional groups of the polymeric weak acid to form a polyvalent cation salt of the polymeric weak acid. The second additive can be an element including, but not limited to calcium or magnesium. The second additive can also be a compound including, but not limited to a weak amine, polyamine, calcium chloride, magnesium chloride, magnesium acetate, magnesium bromide, calcium bromide, ethylene diamine dichloride, and calcium acetate.

According to certain other embodiments for the free acid form and the monovalent cation salt form, the fluid is introduced into a second fluid that contains one or more additives containing polyvalent cations. The second fluid can be a variety of fluids, for example, a drilling mud, spacer fluid, or frac fluid.

According to yet a third embodiment, the additive is in a polyvalent cation salt form that functions to convert the invert emulsion into an emulsion or dispersion without the need for an in-situ ion exchange reaction.

The additive can be in a variety of concentrations. According to certain embodiments, the additive is in a concentration in the range of about 0.5% to about 3% by weight of the base fluid, preferably 0.9% to 1.2%. For the free acid and monovalent salt forms, the additive can be added in a concentration in the range of about 0.2% to about 2%, preferably 0.5% to about 0.7% by weight of the invert emulsion.

The second additive can also be in a variety of concentrations. According to certain embodiments, the second additive is in a concentration in the range of about 0.2% to about 2%, preferably 0.4% to about 0.5% by weight of the base fluid.

The fluid can also contain various other additives. The other additives can be, for example, a water-wetting surfactant, a mutual solvent, a dispersant, a suspending agent, an emulsion-breaking or emulsion-preventing surfactant, a soluble or insoluble weighting agent, a particulate scouring agent, a rheology modifier, etc. The other additives can be in a variety of forms and concentrations.

The fluid can have a variety of desirable properties. The fluid can, for example, have a desired density and viscosity. The viscosity can be selected such that the fluid is pumpable.

According to certain other embodiments, the additive is not included in a base fluid. According to these embodiments, the additive in any of the forms (i.e., a free acid form or monovalent, divalent, or trivalent salt form of the polymeric weak acid) can be added, for example, as a dry powder, to an invert emulsion. If the additive is in the free acid or monovalent salt form, then the additive can be added to a fluid that contains polyvalent cations capable of interacting with the additive to chemically react with the additive to form the polyvalent cation salt of the polymeric weak acid. Alternatively, a second additive in a dry form that contains polyvalent cations capable of chemically reacting with the additive can also be added to the invert emulsion fluid.

Methods of breaking an invert emulsion can include the steps of: introducing the fluid into a wellbore containing an invert emulsion; and allowing the additive to convert the invert emulsion having an external phase comprising a hydrocarbon liquid to an emulsion having an external phase comprising water. According to this method, the method can further include the step of introducing a second fluid into the wellbore after introduction of the fluid, wherein the second fluid comprises polyvalent cations capable of chemically reacting with the polymer additive to form a weak acid polyvalent cation salt via neutralization or ion exchange.

According to certain other embodiments, methods can include introducing a dry form of the additive to an invert emulsion, wherein the additive is a weak acid polyvalent cation salt.

According to yet certain other embodiments, methods can include introducing a dry form of the additive to an invert emulsion. According to this embodiment, the invert emulsion can include polyvalent cations or a second additive including polyvalent cations can be introduced to the invert emulsion.

### Examples

To facilitate a better understanding of the present invention, the following examples of certain aspects of preferred embodiments are given. The following examples are not the only examples that could be given according to the present invention and are not intended to limit the scope of the invention.

Wettability testing was performed using a Fann Wettability Tester, Model C1001. A good result from wettability testing is 175 Hogans (Hn), which indicates that the hydrocarbon liquid external phase of the OBM has converted to an aqueous-based external phase. Samples to be tested were prepared as follows: prepare a fresh oil based mud (OBM) and spacer sample to a density of 15.6 pounds per gallon (ppg) (1,869.3 grams per liter (g/L)) and condition at 190° F. (87.8° C.). The OBM for testing was prepared by mixing:

| | |
|---|---|
| HF-1000 Iso-paraffinic Oil | 18.46%-wt |
| Claytone 3 Oleophylic Clay | 0.38%-wt |
| Calcium Hydroxide | 0.50%-wt |
| Oilpro OME-100 Invert Emulsifier | 1.57%-wt |
| Oilpro OME-33 Oil-Wetting Agent | 0.50%-wt |
| Calcium Chloride, 10% or NaCl, 10% | 12.81%-wt |
| Gilsonite | 1.57%-wt |
| Barite | 64.21%-wt |
| Total: | 100.00%-wt |

The spacer fluid was prepared by mixing:

| | |
|---|---|
| Silica Powder | 3.08%-wt |
| Barite | 60.70%-wt |
| Citric Acid | 0.30%-wt |
| Defoamer | 0.22%-wt |
| Water, Fresh | 35.70%-wt |
| Total: | 100.00%-wt |

The additive to be tested was added to the spacer fluid at a rate of 6 pounds per barrel (ppb) of the spacer fluid prior to conditioning at a concentration in the range of 0.9% to 1.0% by weight of the spacer fluid. A temperature of 190° F. (87.8° C.) for the OBM and spacer fluid was maintained during testing. The wettability tester was set up and calibrated according to the manual. Between 200 and 300 milliliters (mL) of the OBM was added to the blender cup of the wettability tester, shearing was started, and allow for the temperature to equilibrate. Once the temperature had equilibrated, the spacer fluid was added in increments of 50 mL and when the meter reading had stabilized the results were recorded. Additional amounts of the spacer fluid were added until a reading of 175 Hn had been achieved or the maximum volume of spacer fluid had been reached (60% v/v).

The initial, unexpected results of testing various spacer additives are displayed in Table 1 in units of Hn.

TABLE 1

| | | | Spacer | | | |
|---|---|---|---|---|---|---|
| | | | Added | | | |
| Chemistry | Mud type | 33% | 43% | 50% | 56% | 60% |
| Naphthalenesulfonic acid, | CaCl₂ | 0 | 0 | 0 | 35 | 50 |
| formaldehyde condensate, | | | | | | |
| sodium salt | | | | | | |
| Alkylnaphthalenesulfonic | CaCl₂ | 0 | 0 | 0 | 0 | 0 |
| acid, formaldehyde | | | | | | |
| condensate, sodium salt | | | | | | |
| Lignosulfonic acid, sodium | CaCl₂ | 0 | 0 | 0 | 5 | 50 |
| salt | | | | | | |
| Polystyrene sulfonate, sodium | CaCl₂ | 0 | 0 | 0 | 0 | 0 |
| salt | | | | | | |
| Polyacrylic acid, sodium | CaCl₂ | 0 | 0 | 200 | 200 | |
| salt, 3000 MW | | | | | | |
| Polyacrylic acid, sodium | CaCl₂ | 0 | 0 | 175 | 200 | |
| salt, 5000 MW | | | | | | |
| Acrylic acid/AMPS copolymer, | CaCl₂ | 0 | 0 | 200 | 200 | |
| sodium salt | | | | | | |
| Polymaleic acid | CaCl₂ | 0 | 0 | 200 | 200 | |
| Polyitaconic acid | CaCl₂ | 0 | 0 | 0 | 200 | |
| Itaconic acid/AMPS copolymer | CaCl₂ | 0 | 0 | 190 | 200 | |
| Benzylmethacrylate/acrylic | CaCl₂ | 0 | 0 | 0 | 0 | |
| acid/AMPS polymer, sodium | | | | | | |
| salt | | | | | | |
| Acrylic acid/methacrylic | CaCl₂ | 0 | 0 | 0 | 0 | |
| acid/PEG polymer, sodium salt | | | | | | |

Because most OBMs contain calcium chloride in their internal phase, the testing in Table 1 was done using a typical calcium-containing OBM prepared as indicated above. Surprisingly, as can be seen in Table 1, the polymeric weak acids, when contacted with the polyvalent cations of the OBM, achieved very good results and converted the invert emulsion into an emulsion without the presence of a surfactant in the spacer fluid. By contrast, dispersants that are commonly used did not convert the invert emulsion to an emulsion. The polymeric weak acid, in a free acid or monovalent salt form, prior to contact with polyvalent cations is generally water soluble. However, without being limited by theory, it is believed that after contact with polyvalent cations, the polyvalent salt of the weak acid polymer becomes less water soluble and migrates to the water/oil interface.

Further work was done to determine the effect of monovalent versus polyvalent cations as well as other polymers and copolymers, with the results shown in Table 2 in units of Hn.

TABLE 2

| | | | Spacer | | |
|---|---|---|---|---|---|
| | | | Added | | |
| Chemistry | Mud type | 33% | 43% | 50% | 56% |
| Sodium | CaCl₂ | 0 | 0 | 170 | 200 |
| polyacrylate, | | | | | |
| alt. source | | | | | |
| Calcium | CaCl₂ | 0 | 0 | 0 | 100-200 |
| polyacrylate | | | | | |
| Calcium | NaCl | 0 | 0 | 200 | 200 |
| polyacrylate | | | | | |
| Magnesium | CaCl₂ | 0 | 0 | 0 | 85 |
| polyacrylate | | | | | |
| Magnesium | NaCl | 0 | 0 | 0 | 180 |
| polyacrylate | | | | | |
| Ethylene diamine | CaCl₂ | 0 | 0 | 0 | 175 |
| polyacrylate | | | | | |
| Ethylene diamine | NaCl | 0 | 0 | 200 | 200 |
| polyacrylate | | | | | |
| Magnesium | CaCl₂ | 0 | 0 | 0 | 175 |
| polymaleate | | | | | |
| Magnesium | NaCl | 0 | 0 | 35 | 200 |
| polymaleate | | | | | |

However, because not all OBMs contain calcium, further testing with various polymeric weak acids in both un-neutralized and in various salt forms was performed. Some of those pertinent results are listed in Table 2. As can be seen in the results, it has been found that the novel phenomenon described herein requires the use of 1) a polymeric weak acid in conjunction with at least one polyvalent cation, 2) the polymeric weak acid may have a variety of compositions, including a heterogeneous copolymer that may further include some strong acid groups, and have a variety of molecular weights, and 3) the polyvalent cation(s) needed may either be added separately along with the polymeric weak acid, as a salt of the polymeric weak acid, or simply already be present in the invert emulsion to be treated.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention.

As used herein, the words “comprise,” “have,” “include,” and all grammatical variations thereof are each intended to have an open, non-limiting meaning that does not exclude additional elements or steps. While compositions, systems, and methods are described in terms of “comprising,” “containing,” or “including” various components or steps, the compositions, systems, and methods also can “consist essentially of” or “consist of” the various components and steps. It should also be understood that, as used herein, “first,” “second,” and “third,” are assigned arbitrarily and are merely intended to differentiate between two or more fluids, additives, etc., as the case may be, and does not indicate any sequence. Furthermore, it is to be understood that the mere use of the word “first” does not require that there be any “second,” and the mere use of the word “second” does not require that there be any “third,” etc.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A treatment fluid comprising:
a base fluid; and
an additive,
wherein the additive comprises a weak acid polymer, wherein the weak acid polymer chemically reacts with polyvalent cations to form a weak acid polyvalent cation salt via neutralization or ion exchange, and wherein the additive converts an invert emulsion having an external phase comprising a hydrocarbon liquid to an emulsion having an external phase comprising water.

2. The fluid according to claim 1, wherein the base fluid comprises an aqueous liquid.

3. The fluid according to claim 1, wherein the base fluid comprises a hydrocarbon liquid.

4. The fluid according to claim 1, wherein the additive is soluble in an aqueous liquid or a hydrocarbon liquid.

5. The fluid according to claim 1, wherein the weak acid polymer has a molecular weight in the range of 200 to 500,000.

6. The fluid according to claim 1, wherein the weak acid polymer is selected from the group consisting of polycarboxylates, polyacrylates, polymaleates, polymethacrylates, polyfumarates, polyitaconates, polyacrylic acid, polymethacrylic acid, polyitaconic acid, polyfumaric acid, or polymaleic acid.

7. The fluid according to claim 1, wherein the weak acid polymer is in a monovalent salt form.

8. The fluid according to claim 1, wherein the weak acid polymer is in a free acid form.

9. The fluid according to claim 1, further comprising a second additive, wherein the second additive comprises polyvalent cations.

10. The fluid according to claim 9, wherein the second additive is in a concentration in the range of about 0.2% to about 2% by weight of the base fluid.

11. The fluid according to claim 1, wherein the additive is in a concentration in the range of about 0.5% to about 3% by weight of the base fluid.

12. A treatment fluid comprising:
a base fluid; and
an additive,
wherein the additive comprises a divalent or trivalent salt of a weak acid polymer, and
wherein the additive converts an invert emulsion having an external phase comprising a hydrocarbon liquid into an emulsion having an external phase comprising water.

13. The fluid according to claim 12, wherein the base fluid comprises an aqueous liquid.

14. The fluid according to claim 12, wherein the base fluid comprises a hydrocarbon liquid.

15. The fluid according to claim 12, wherein the weak acid polymer has a molecular weight in the range of 1,000 to 100,000.

16. The fluid according to claim 12, wherein the additive is a calcium, magnesium, or diamine salt of the weak acid polymer.

17. The fluid according to claim 12, wherein the weak acid polymer is selected from the group consisting of polycarboxylates, polyacrylates, polymaleates, polymethacrylates, polyfumarates, polyitaconates, polyacrylic acid, polymethacrylic acid, polyitaconic acid, polyfumaric acid, or polymaleic acid.

18. An additive comprising:
a polymeric weak acid, wherein the polymeric weak acid is in a free acid form or in a monovalent, divalent, or trivalent salt form of the polymeric weak acid, and wherein the additive converts an invert emulsion having an external phase comprising a hydrocarbon liquid to an emulsion having an external phase comprising water.

19. The additive according to claim 18, wherein the weak acid polymer is selected from the group consisting of polycarboxylates, polyacrylates, polymaleates, polymethacrylates, polyfumarates, polyitaconates, polyacrylic acid, polymethacrylic acid, polyitaconic acid, polyfumaric acid, or polymaleic acid.

20. A method of breaking an invert emulsion comprises:
introducing a fluid into a wellbore containing the invert emulsion,
wherein the fluid comprises a base fluid and an additive, and
wherein the additive comprises a weak acid polymer; and
allowing the additive to convert the invert emulsion to an emulsion having an external phase comprising water.
